(19) United States
(12) Patent Application Publication
(10) Pub. No.: US 2015/0215246 A1
(43) Pub. Date: Jul. 30, 2015

(54) MESSAGING AND TASK MANAGEMENT DEVICE AND METHOD THEREOF

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHANG-FONG LUNG, New Taipei (TW); JUN LIANG, Wuhan (CN)

(21) Appl. No.: 14/522,399

(22) Filed: Oct. 23, 2014

(30) Foreign Application Priority Data
Jan. 25, 2014 (CN) 201410034658.4

(51) Int. Cl. H04L 12/58; G06F 3/0484; G06F 3/0482

(52) U.S. Cl. CPC H04L 51/046; G06F 3/0482; G06F 3/04842

(57) ABSTRACT

A method for organizing a task includes creating the task in an application run in an electronic device, selecting one or more other users to join the task, adding the task to a schedule of a first user and the selected users who use the application, and determining a best communication system to use to inform the selected users about the task. The application includes a number of embedded communication systems. Message correspondence records of all of the embedded communication systems are displayable on a single interface of the application. The first user can send messages to other users through the embedded communication systems, and receive messages from the other users through the corresponding embedded communication systems. The task is created by the first user selecting one or more messages from a message correspondence record of the embedded communication systems.

### FIELD

The present disclosure relates to applications of electronic devices, and particularly to an application that can create a task from a message correspondence record.

### BACKGROUND

Some applications of electronic devices allow users to send and receive messages. Each application may have its own messaging system and record a corresponding message record of correspondence with a plurality of contacts.

### BRIEF DESCRIPTION OF THE DRAWINGS

Implementations of the present technology will now be described, by way of example only, with reference to the attached figures.

FIG. 1 is a block diagram of an exemplary embodiment of a messaging and task management device.

FIG. 2 is a diagrammatic view of a message correspondence record of the application.

FIG. 3 is a diagrammatic view of a plurality of information of a task created from the message correspondence record of FIG. 2.

FIG. 4 is a diagrammatic view of a list of upcoming and overdue tasks.

FIG. 5 is a diagrammatic view of a plurality of users listed in the application.

FIGS. 6-10 are diagrammatic views of contact information of each user, the contact information displayed on corresponding interfaces of the application.

FIG. 11 is a diagrammatic view of a record of instant message correspondence with all contacts.

FIG. 12 is a diagrammatic view of a record of telephone and SMS message correspondence with all contacts.

FIG. 13 is a diagrammatic view of a record of missed telephone calls from all contacts.

FIG. 14 is a diagrammatic view of a schedule of tasks arranged by month.

FIG. 15 is a diagrammatic view of a schedule of tasks arranged by week.

FIG. 16 is a diagrammatic view of a schedule of tasks arranged by day.

FIG. 17 is a diagrammatic view of a home page of the application.

FIG. 18 is a flowchart of an exemplary embodiment of a method for creating a task from a message record.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

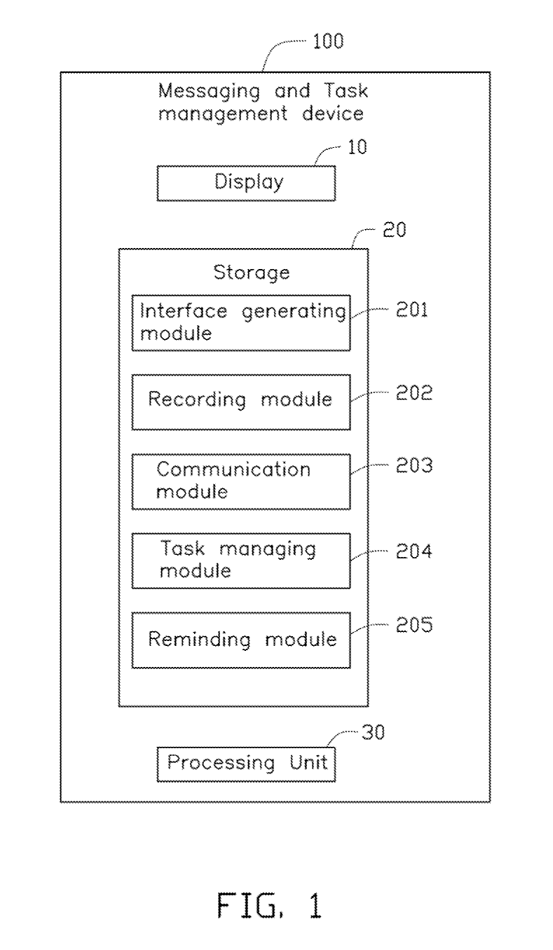

FIG. 1 illustrates an exemplary embodiment of a messaging and task management device 100 (hereinafter “the device 100”). In at least one embodiment, the device 100 can be an electronic device such as a mobile phone. The device 100 can include a display 10, at least one storage unit 20, and at least one processing unit 30. The device 100 can further include a plurality of modules, such as an interface generating module 201, a recording module 202, a communication module 203, a task managing module 204, and a reminding module 205. The modules 201-205 can include one or more software programs in the form of computerized codes stored in the storage unit 20. The computerized codes can include instructions that can be executed by the processing unit 30 to provide functions for the modules 201-205.

The interface generating module 201 can generate and display a plurality of interfaces of the application on the display 10. The plurality of interfaces can be operable by a user to carry out functions of the application.

The recording module 202 can record a plurality of information of the application to the storage unit 20. The plurality of information of the application can be displayed on corresponding interfaces of the application.

The communication module 203 can allow a user of the electronic device 100 (hereinafter “the first user”) to send messages to other users through imbedded communication systems of the application. The communication module 203 also allows the first user to receive messages from the other users through the corresponding imbedded communication systems. The messages can be text-type messages, audio-type messages, or other type of message. All messages of all of the embedded communication systems are displayable together on a single interface and on corresponding interfaces of the application. In at least one embodiment, the embedded communication systems can include a telephone system, an SMS text message system, an instant message system, and an email system. In other embodiments, other communication systems can be imbedded in the application.

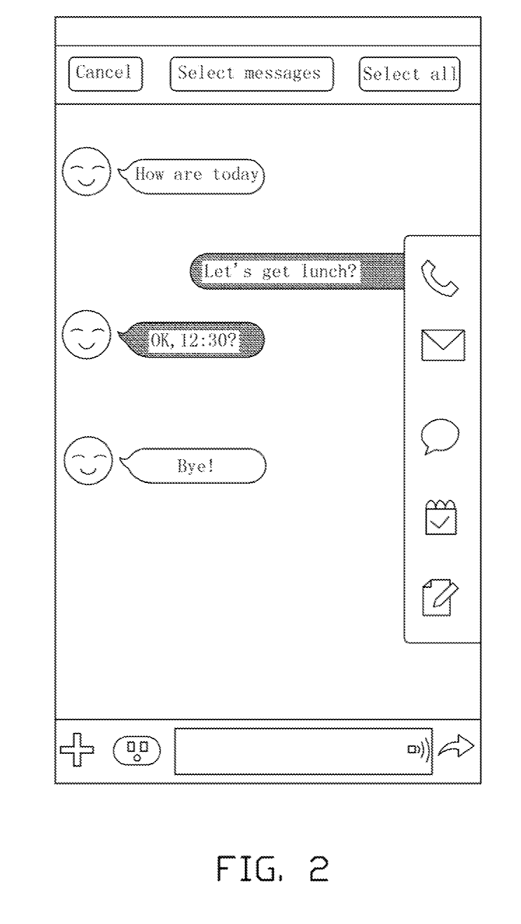

FIG. 2 illustrates an exemplary embodiment of a message correspondence record of one of the embedded communication systems. The message correspondence record can be between the first user and one other user, or among the first user and more than one other users.

In at least one embodiment, any message of the message correspondence record can be selected by the first user to create a task. The task can be an event to be added to a schedule of the first user. After one or more messages are selected by the first user, a plurality of shortcut buttons can be displayed on the display. In at least one embodiment, the plurality of shortcut buttons can include a button to call a telephone of a user, a button to send an SMS message to a user, a button to send an instant message to a user, a button to add selected messages to a list of saved messages, and a button to create a task. In other embodiments, the plurality of shortcut buttons can include other buttons having other functions. The first user can select the button to create a task to create the task. In at least one embodiment, the communication module 203 can operate over a communication network or a local area network based on BLUETOOTH, ZIGBEE, or WIFI, for example.

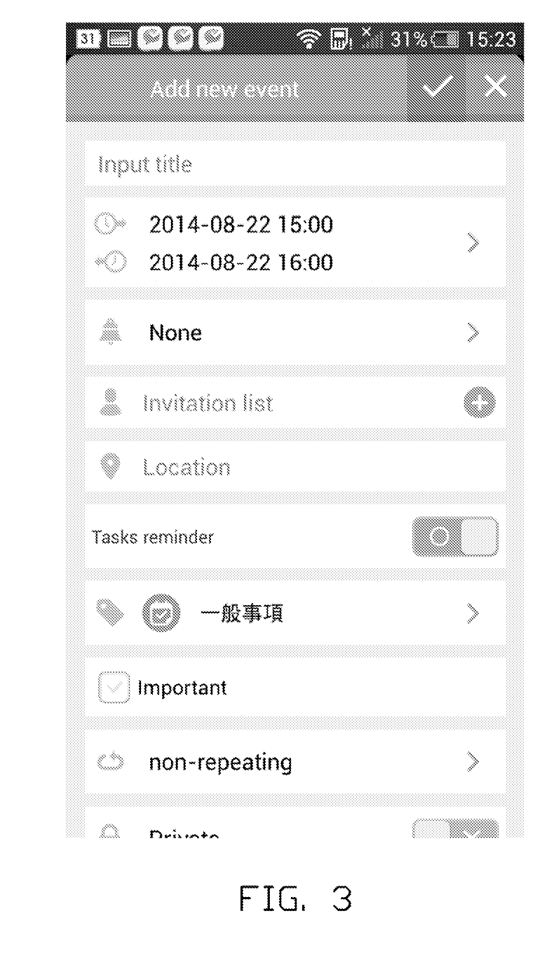

Referring to FIG. 3, information of the task can include a task name, a date and start time of the task, and one or more selected users to join the task. In other embodiments, the information can include the selected messages from the message correspondence record. After the task is created, the task managing module 204 (as shown in FIG. 1) can add the task to a schedule of the first user. The task managing module 204 can determine whether the selected users use the application, and determine a best communication system to use to inform the selected users about the task. The best communication system to use to inform the selected users about the task can be determined by an urgency of the task. In at least one embodiment, the task is urgent when the date and start time of the task are within a predetermined time period set by the first user, and a priority of the communication systems to use to inform the selected users can be set by the first user.

When the task managing module 204 determines that the selected users use the application, the task managing module 204 can send an invitation to the selected users. The task managing module 204 can add the task to a schedule of the selected users after the selected users accept the invitation.

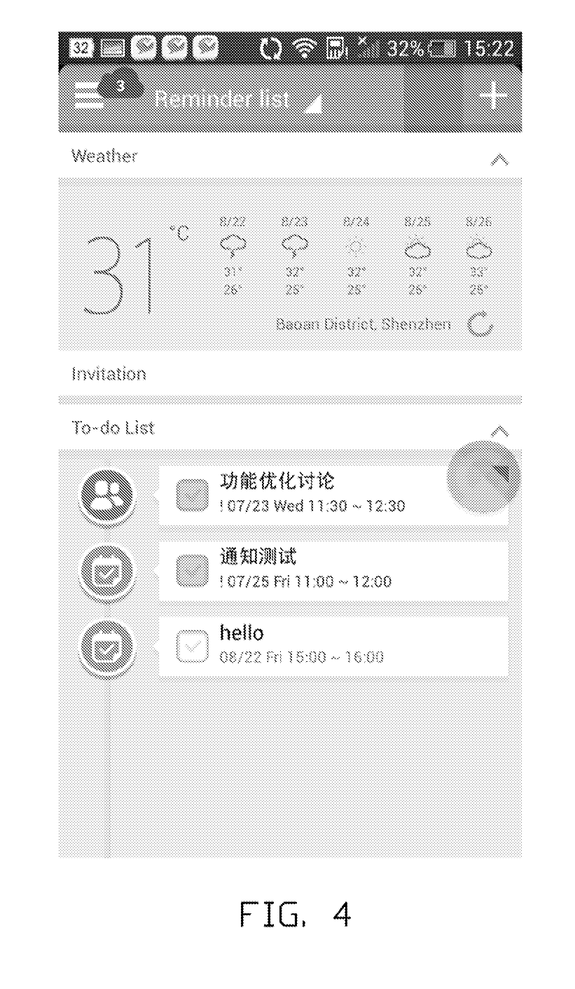

Referring to FIG. 4, the task managing module 204 (as shown in FIG. 1) can check the schedule, and arrange any upcoming tasks in a list in the application. The task managing module 204 can also list any tasks that are overdue.

The reminding module 205 can send a reminder (not shown) to the first user and the one or more selected users at a predetermined time before the start time of the task.

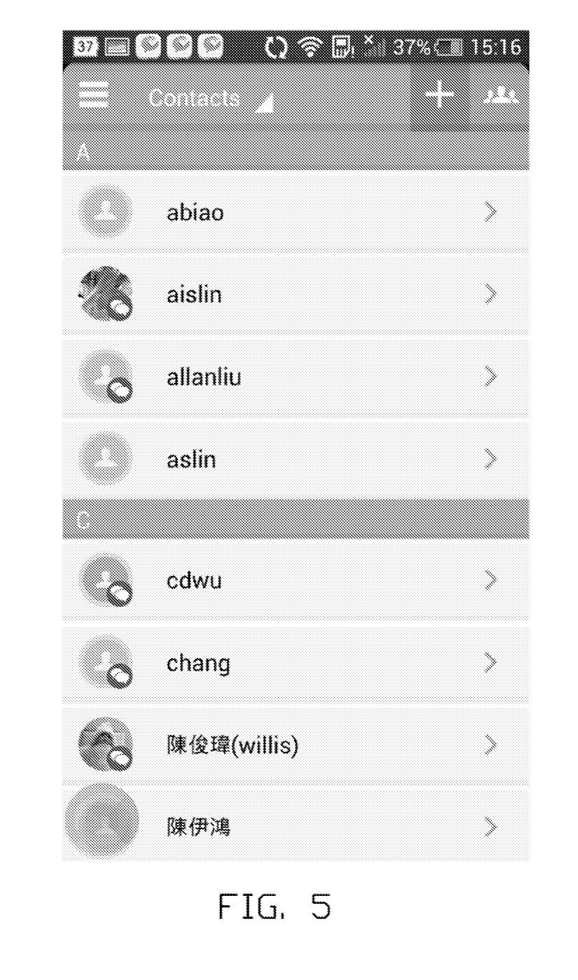

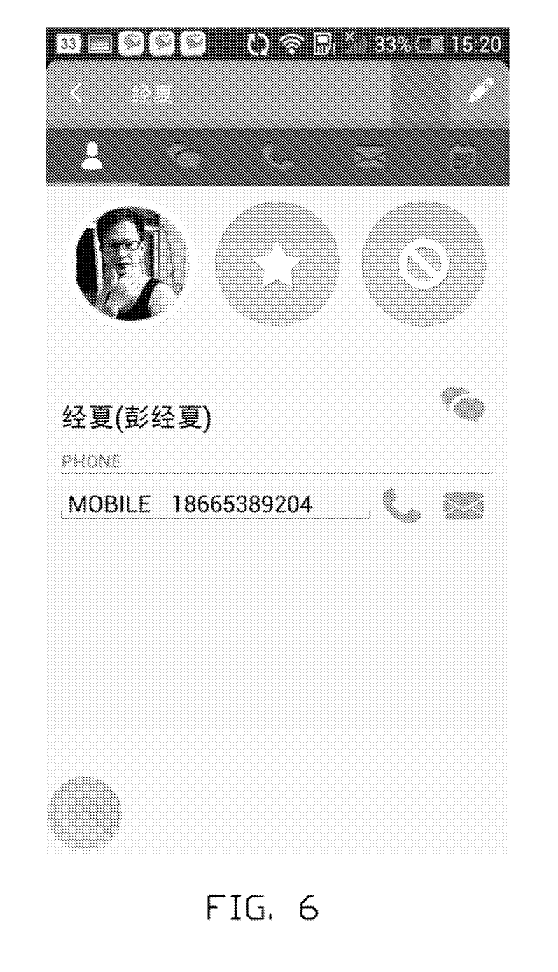

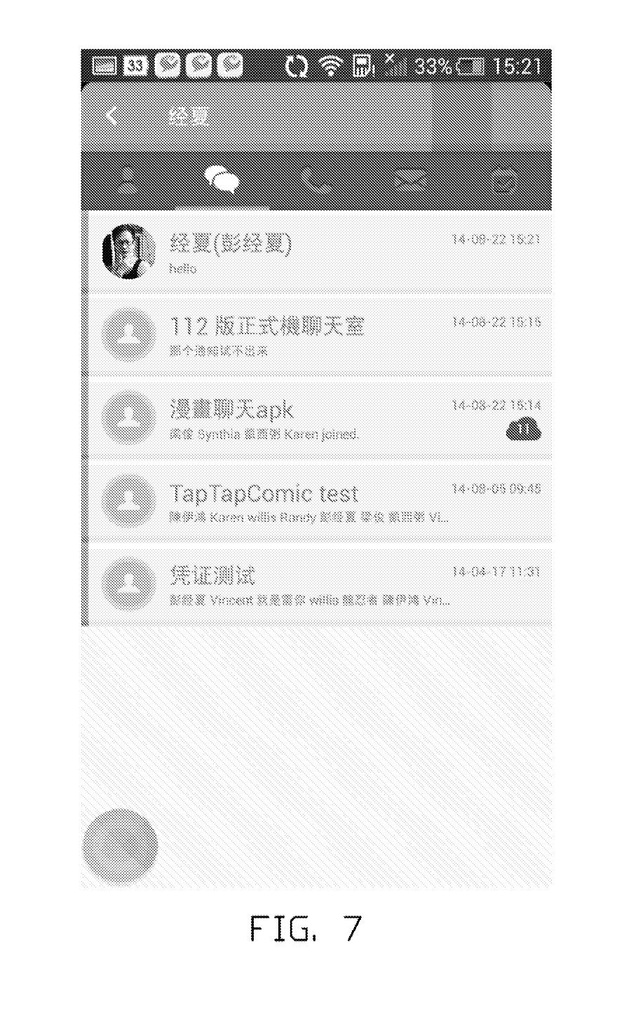

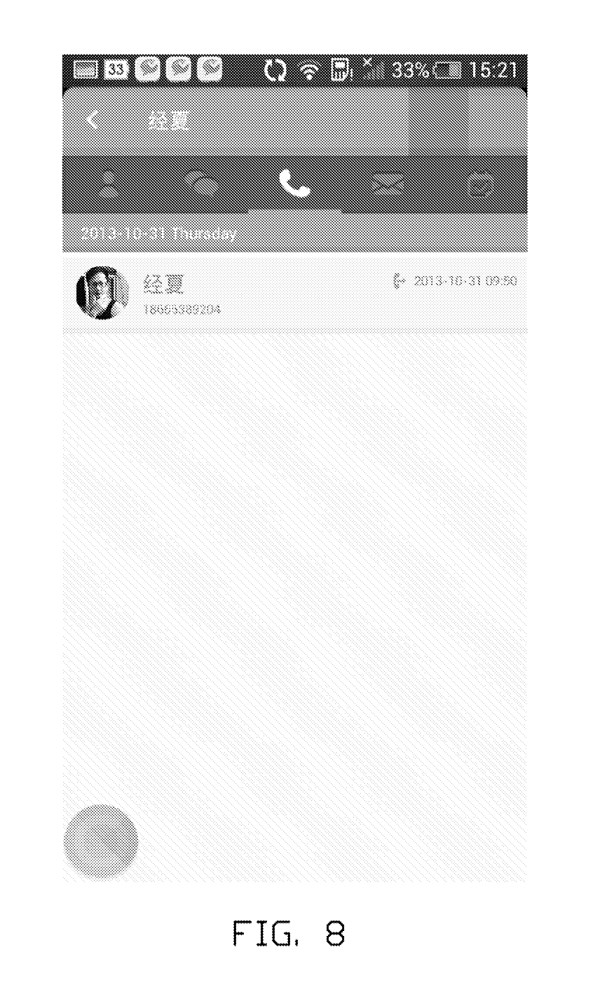

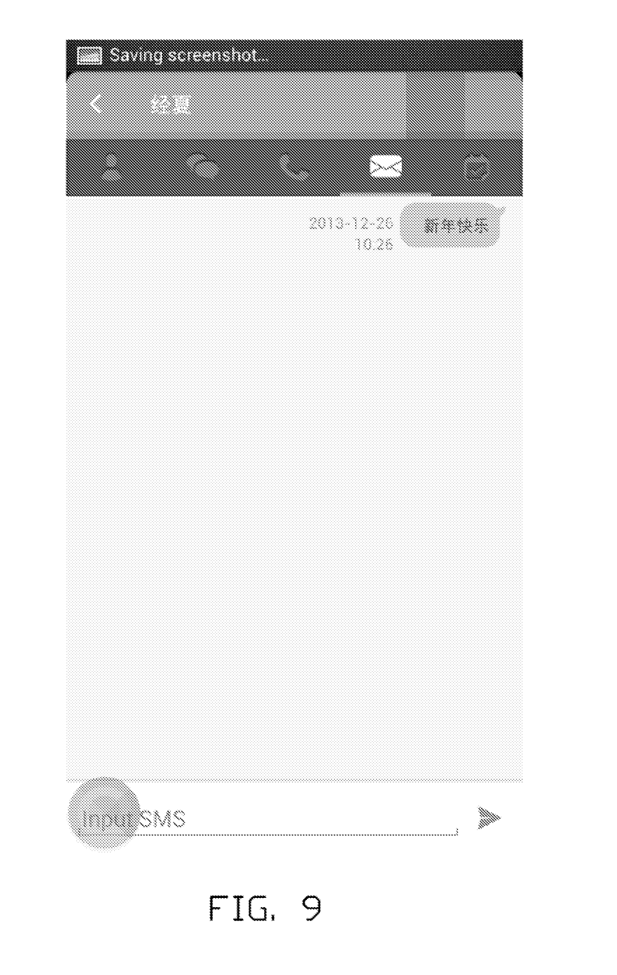

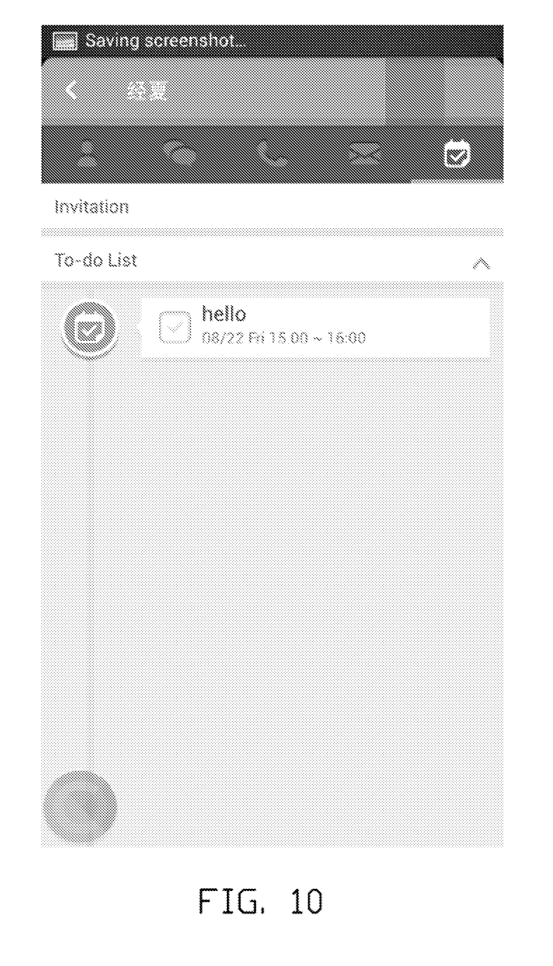

Referring to FIGS. 5-10, the application can store contact information of a plurality of users. In at least one embodiment, the contact information of each user can include a telephone number, an SMS number, an email address, an instant message username, a record of previous instant message correspondence with the user, a record of previous telephone correspondence with the user, a record of previous SMS message correspondence with the user, a record of previous email correspondence with the user, and a record of all tasks involving the user.

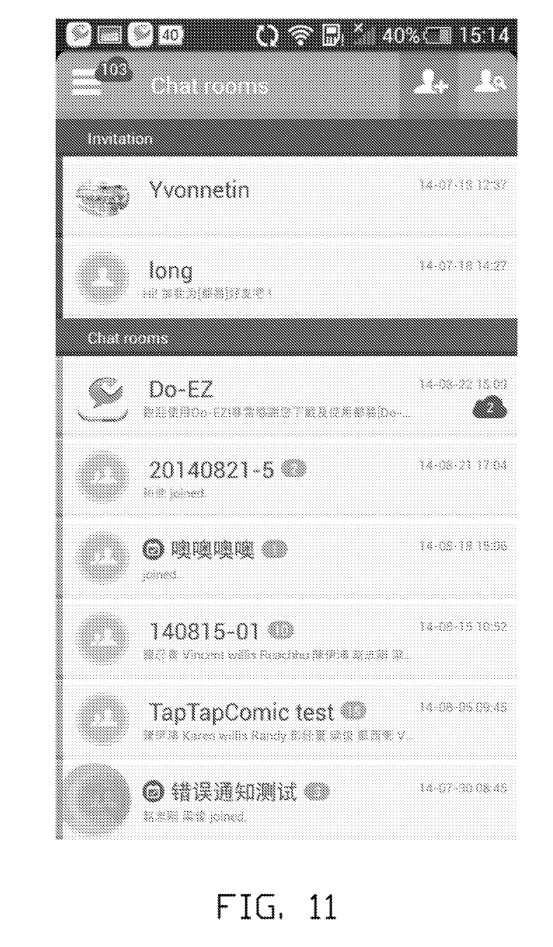

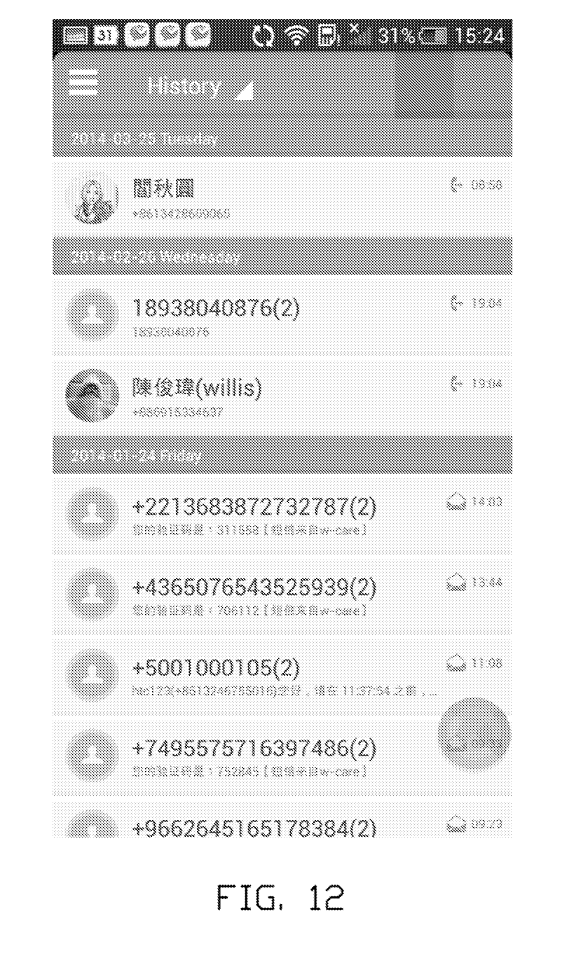

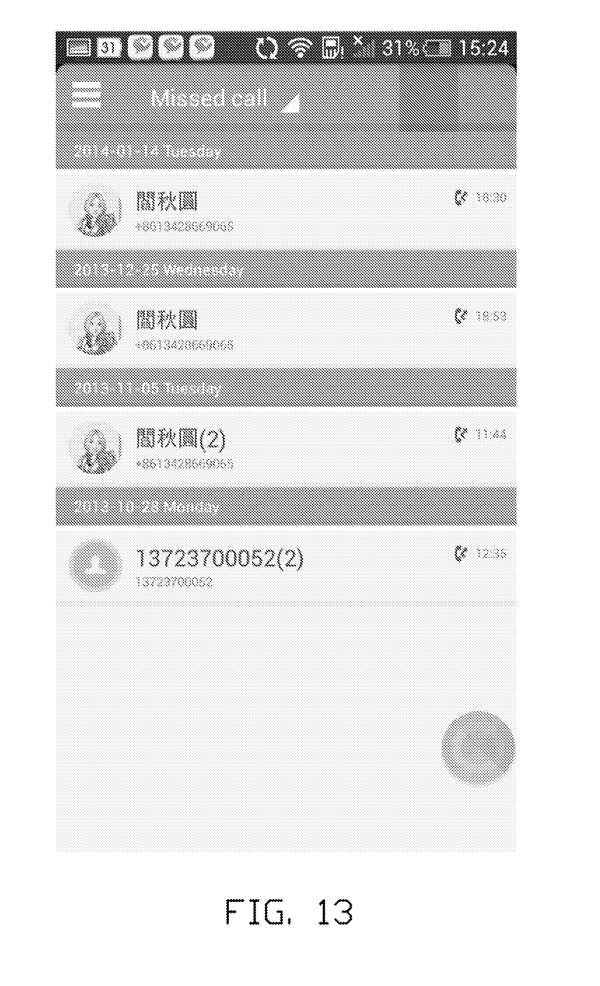

Referring to FIGS. 11-13, the application can display all message correspondence records of all of the embedded communication systems on a single interface and on corresponding interfaces. Thus, the user of the application does not need to open separate applications to see the message correspondence records of the different communication systems.

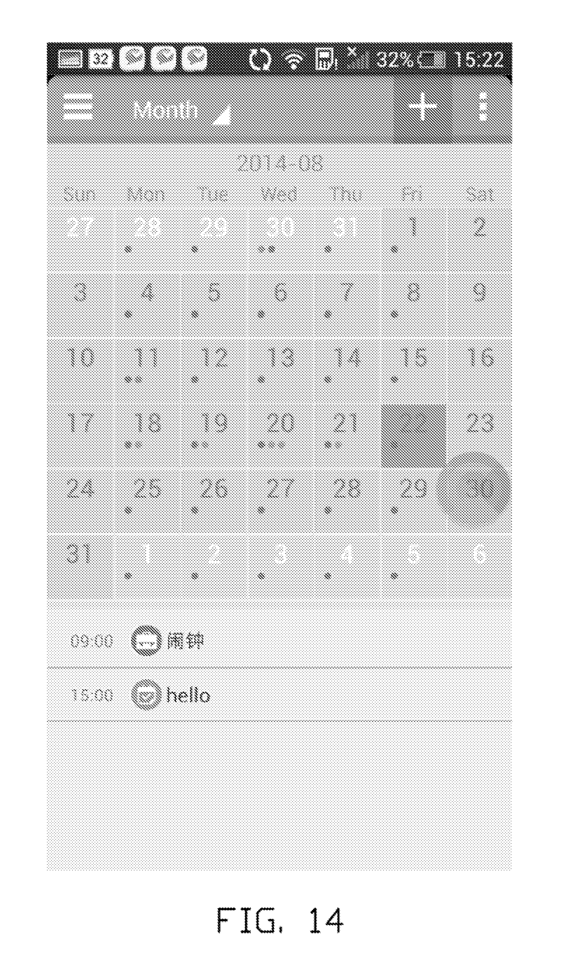

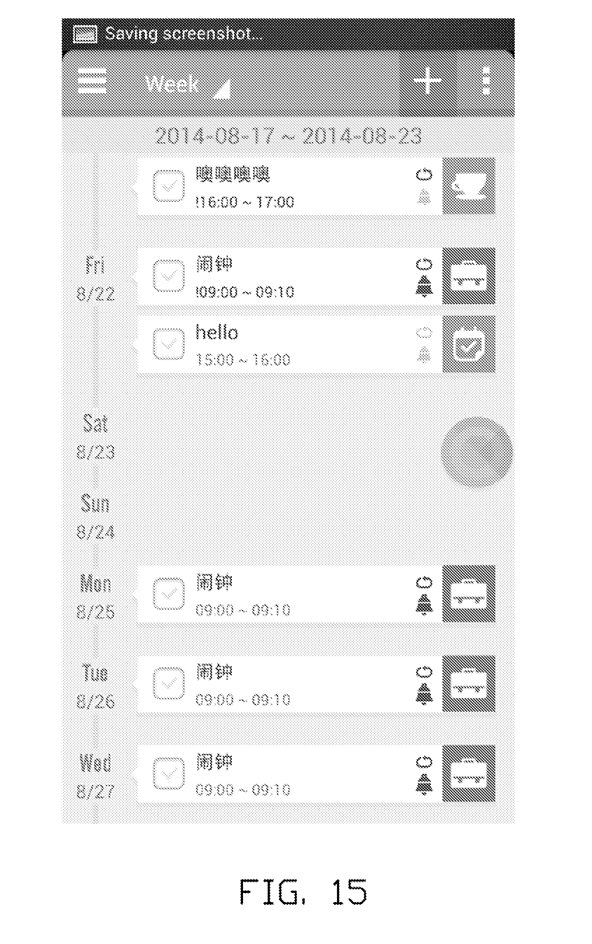

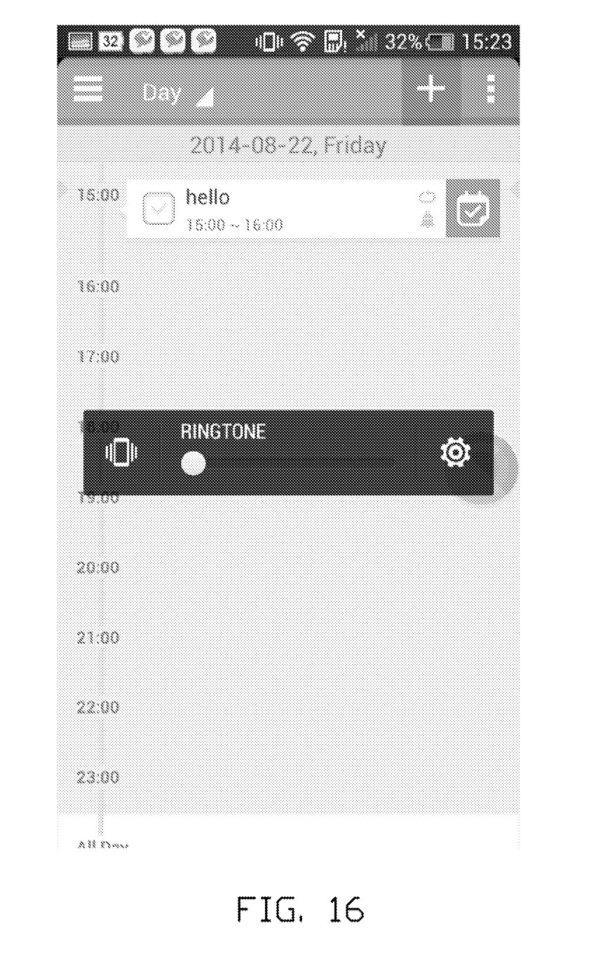

FIGS. 14-16 illustrate a schedule of the tasks. In at least one embodiment, the tasks can be arranged and displayed according to month, week, and day.

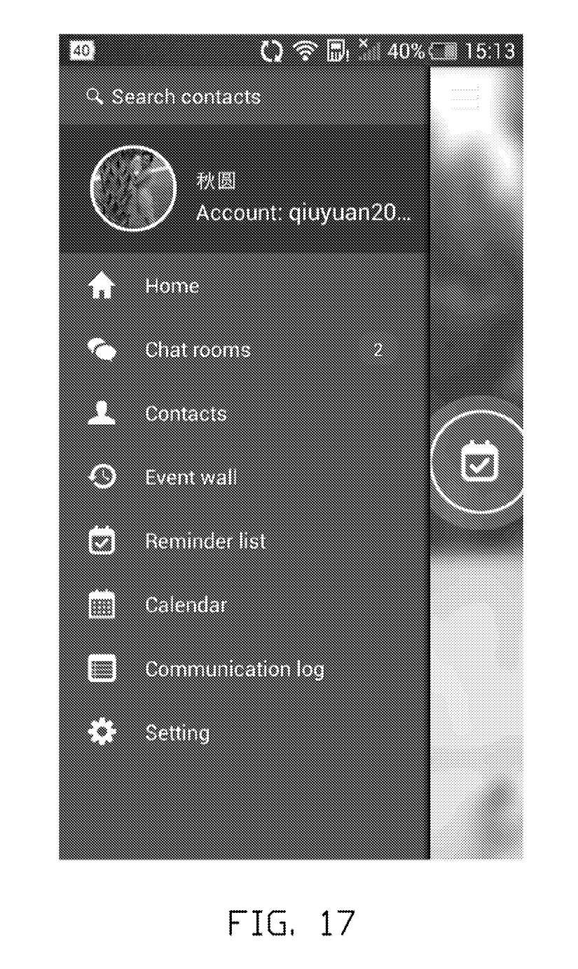

FIG. 17 illustrates an exemplary embodiment of a home page of the application. The home page can include a main menu to navigate the plurality of interfaces of the application.

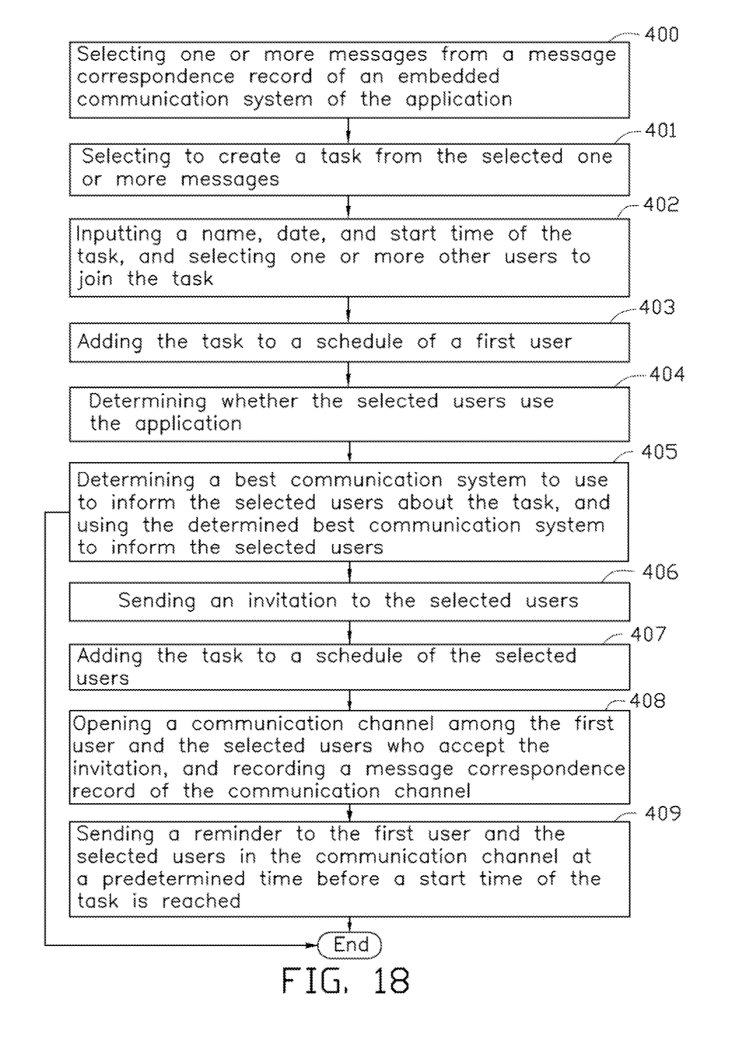

FIG. 18 illustrates an exemplary embodiment of a flowchart of a method of creating a task in an application run in an electronic device. The example method is provided by way of example, as there are a variety of ways to carry out the method. The method described below can be carried out using the configurations illustrated in FIGS. 1-17, for example, and various elements of these figures are referenced in explaining the example method. Each block shown in FIG. 18 represents one or more processes, methods, or subroutines carried out in the example method. Furthermore, the illustrated order of blocks is by example only, and the order of the blocks can be changed. The example method can begin at block 400.

At block 400, one or more messages from a message correspondence record of an embedded communication system of the application are selected by a first user.

At block 401, an option to create a task from the selected one or more messages is selected.

At block 402, a name, date, and start time of the task are inputted, and one or more other users are selected to join the task.

At block 403, the task is added to a schedule of the first user.

At block 404, whether the selected users use the application is determined.

At block 405, a best communication system to use to inform the selected users about the task is determined, and the determined best communication system is used to inform the selected users about the task. The best communication system to use to inform the selected users about the task can be determined by an urgency of the task. In at least one embodiment, the task is urgent when the date and start time of the task are within a predetermined time period set by the first user, and a priority of the communication systems to use to inform the selected users can be set by the first user. If the selected users use the application, block 406 is implemented. Otherwise, if the selected users do not use the application, the method ends.

At block 406, an invitation is sent to the selected users who use the application to join the task.

At block 407, the task is added to a schedule of the selected users who accept the invitation.

At block 408, a communication channel is opened among the first user and the selected users who accept the invitation, and a message correspondence record of the communication channel is recorded.

At block 409, a reminder is sent to the first user and the selected users in the communication channel at a predetermined time before a start time of the task is reached.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A messaging and task management device comprising:
at least one storage unit configured to store a plurality of modules, which is a collection of instructions of an application run in the device; and
at least one processing unit configured to execute the plurality of modules, the modules comprising:
an interface generating module configured to generate and display a plurality of interfaces of the application on a display of the device, the plurality of interfaces operable by a user to execute functions of the application;
a recording module configured to record a plurality of information of the application to the at least one storage unit, the plurality of information being displayable on corresponding interfaces by the interface generating module;
a communication module configured to allow a first user to send messages to other users through embedded communication systems of the application, and receive messages from the other users through the corresponding embedded communication systems, all messages of all embedded communication systems being displayable together on a single interface and on corresponding interfaces of the application; and
a task managing module configured to create a task in response to the first user's input, and save the task to a schedule of the first user;
wherein:
the task includes one or more other users selected by the first user to participate in the task;
a message type of the messages comprises a text type and an audio type;
the embedded communication systems comprise an instant message system, an email system, an SMS text message system, and a telephone system;
after the task is created by the first user, the task managing module determines whether the selected users use the application; and
after the task is created by the first user, the task managing module determines a best communication system to use to inform the selected users about the task.

2. The device as in claim 1, wherein the interface generating module displays a plurality of shortcut buttons on corresponding interfaces of the application when designated elements of the interfaces are operated by a user; the plurality of shortcut buttons comprises:
a button to call a telephone of a corresponding user when operated;
a button to send an SMS message to the corresponding user when operated;
a button to send an instant message to the corresponding user when operated;
a button to send an email to the corresponding user when operated;
a button to create a task; and
a button to add selected messages to a list of saved messages, the saved messages being sharable with at least one selected user;
wherein designated shortcut buttons of the plurality of shortcut buttons are displayed in designated interfaces when the designated elements are operated.

3. The device as in claim 2, wherein:
when the task managing module determines that the selected users use the application:
the task managing module sends an invitation to the selected users to accept the task;
the task managing module adds the task to a schedule of the selected users after the invitation is accepted;
after the selected users accept the invitation, a communication channel is opened among the first user and the selected users who accept the invitation; and
a message correspondence record of the communication channel is recorded.

4. The device as in claim 1, wherein the task managing module determines the best communication system to use to inform the selected users by determining whether the task is urgent; the task is urgent when the date and start time of the task are within a predetermined time period set by the first user; and a priority of the communication systems to use to inform the selected users is set by the first user.

5. The device as in claim 2, wherein the task is created by:
selecting one or more messages from a message record of the embedded communication systems;
operating the task button;
inputting a task name and a date and start time of the task; and
selecting the other users to join the task;
wherein information of the task comprises the name of the task, the date and start time of the task, the selected users, and the selected messages; and
the text-type messages and the audio-type messages are both selectable to create the task.

6. The device as in claim 1, wherein the plurality of modules further comprises a reminding module configured to send a reminder to the first user at a predetermined time before the start time of the task is reached; and when the task managing module determines that the task has been added to the schedules of the selected users, the reminding module sends the reminder to the selected users.

7. The device as in claim 1, wherein the plurality of information recorded by the recording module comprises contact information of the other users; the contact information of each user comprises a contact name, a phone number, an SMS number, an email address, and an instant message username; the communication module allows the first user to send messages to the other users through the corresponding communication systems according to the corresponding contact information.

8. The device as in claim 7, wherein the plurality of information recorded by the recording module further comprises a telephone correspondence record, an SMS correspondence record, an email correspondence record, and an instant message correspondence record with each user; the telephone, SMS, email, and instant message correspondence records are displayable together on a single interface and on corresponding interfaces of the application, and are arranged according to time, communication system, user, and other suitable arrangement system set by the first user.

9. The device as in claim 7, wherein the plurality of information further comprises a record of all instant messages that have not been read yet, a record of all SMS messages that have not been read yet, a record of all telephone calls that have not been answered, and a record of all emails that have not been read yet; and the record of instant messages, SMS messages, telephone calls, and emails that have not been read or answered are displayable together on a single interface and on corresponding interfaces of the application, and are arranged according to time, communication system, user, and other suitable arrangement system set by the first user.

10. The device as in claim 7, wherein the plurality of information further comprises a record of all upcoming tasks; the upcoming tasks are arranged and displayed together on a single interface and on corresponding interfaces of the application, and are arranged according to time, user, or other arrangement set by the first user; and the schedule of all the tasks is displayable according to day, week, month, and other suitable arrangement system set by the first user.

11. The device as in claim 7, wherein the plurality of information further comprises a record of tasks that have passed the starting time and date; and the record of tasks that have passed the starting time and date are displayed together on a single interface and on corresponding interfaces of the application, and are arranged according to time, user, and other suitable arrangement system set by the first user.

12. A method for organizing a task comprising:
creating the task in an application comprising a plurality of imbedded communication systems;
selecting one or more other users to join the task;
adding the task to a schedule of a first user;
determining whether the selected users use the application; and
determining a best communication system to use to inform the selected users about the task;
wherein the selected users are selected by the first user to join the task.

13. The method as in claim 12, wherein the best communication system to use to inform the selected users is determined by determining whether the task is urgent; the task is urgent when the date and start time of the task are within a predetermined time period set by the first user; and a priority of the communication systems to use to inform the selected users is set by the first user.

14. The method as in claim 12 further comprising:
upon determining that the selected users use the application, sending an invitation to the selected users, and adding the task to a schedule of the selected users after the invitation is accepted.

15. The method as in claim 12, wherein the task is created by:
selecting one or more messages from a message record of one or more of the embedded communication systems;
selecting an option to create the task with the selected one or more messages;
inputting a task name and a date and start time of the task; and
selecting the other users to join the task;
wherein information of the task comprises the name of the task, the date and start time of the task, the selected users, and the selected messages; and
the messages are selectable from text-type messages and audio-type messages.

16. The method as in claim 12, wherein the task is created by:
selecting an option to create the task;
inputting a task name and a date and start time of the task;
and selecting the other users to join the task;
wherein information of the task comprises the name of the task, the date and start time of the task, and the selected users; and
a communication channel is opened among the first user and all the selected users, and a message correspondence record of the communication channel is recorded.
